(19) United States
(12) Patent Application Publication
(10) Pub. No.: US 2026/0281505 A1
(43) Pub. Date: Sep. 17, 2026

(54) METHOD AND APPARATUS FOR CONTENT RECOMMENDATION IN CONTENT STREAMING SYSTEM

(71) Applicant: TVING CO., LTD., Seoul (KR)

(72) Inventors: Gun Mo GOO, Chuncheon (KR); Hyeon Woo AN, Yongin (KR)

(21) Appl. No.: 19/677,068

(22) Filed: May 14, 2026

Related U.S. Application Data
(63) Continuation of application No. PCT/KR2024/096611, filed on Nov. 18, 2024.

(30) Foreign Application Priority Data
Nov. 16, 2023 (KR) 10-2023-0158917

(51) Int. Cl. H04N 21/466

(52) U.S. Cl. CPC H04N 21/4668

(57) ABSTRACT

Disclosed herein are a learning method and device for a model for content recommendation in a content streaming system, and the learning method for a model for content recommendation may include obtaining target domain information related to at least one of a user or an item, obtaining auxiliary domain information related to at least one of a user or an item, generating a cross-domain-based factorization machine (FM) model, and performing learning by inputting the target domain information and the auxiliary domain information into the cross-domain-based FM model.

### CROSS-REFERENCE TO RELATED APPLICATION

The present application is a by-pass continuation application claiming the benefit under 35 U.S.C. § 120 to International Patent Application No. PCT/KR2024/096611 filed on Nov. 18, 2024, which claims priority to a Korean Patent Application No. 10-2023-0158917, filed Nov. 16, 2023, the entire contents of each of which are incorporated herein for all purposes by this reference.

### TECHNICAL FIELD

The present disclosure relates to a content streaming system, and more particularly, to a method and apparatus for content recommendation in a content streaming system.

### BACKGROUND

With the development of various technologies and changes in consumption trends, a great change has occurred in the way content is supplied and consumed. The development of digital technology, computer technology, Internet/communication technology, etc. has blurred the boundaries of the type of content and the subject of production, which has caused a great change in the creation and consumption patterns of content. Platforms have emerged that allow ordinary people to create and distribute content. In addition, ease of access to various contents has been secured, and various options for consumption methods have begun to be provided.

Among these many changes in the content industry, OTT (over the top) services exist. OTT service is a media platform based on Internet and mobile communication, and provides various contents to consumers without equipment such as a separate set-top box beyond existing broadcasting services. The concept of OTT service started by providing movies and television programs in the form of video on demand (VOD), but the OTT service is still expanding, by not only providing content created by OTT service providers but also expanding its scope to mobile platforms.

### SUMMARY

The present disclosure is directed to providing a method and apparatus for content recommendation in a content streaming system.

The present disclosure is directed to recommending a content based on a cross-domain-based factorization machine (FM) model in a content streaming system.

The present disclosure is directed to solving a cold-start problem by using a cross-domain-based FM model.

The present disclosure is directed to efficiently generating an interface for content recommendation by using a cross-domain-based FM model.

According to an embodiment of the present disclosure, a method for content recommendation in a content streaming system may include obtaining target domain information related to at least one of a user or an item, obtaining auxiliary domain information related to at least one of a user or an item, generating a cross-domain-based factorization machine (FM) model, and performing learning by inputting the target domain information and the auxiliary domain information into the cross-domain-based FM model.

According to an embodiment of the present disclosure, the target domain information may include at least one of a user parameter for a target domain or an item parameter for the target domain.

According to an embodiment of the present disclosure, the user parameter for the target domain may indicate a user identifier, and the item parameter for the target domain may indicate an item identifier.

According to an embodiment of the present disclosure, the auxiliary domain information may include at least one of a user parameter for an auxiliary domain or an item parameter for the auxiliary domain.

According to an embodiment of the present disclosure, the user parameter for the auxiliary domain may indicate a content use frequency of the user, and the item parameter for the auxiliary domain may indicate at least one of an identifier of at least one previously watched content and a complete watch rate for the at least one previously watched content.

According to an embodiment of the present disclosure, the target domain may include information related to a specific content category to be recommended by the content streaming system.

According to an embodiment of the present disclosure, the auxiliary domain may include information related to a content category with a high similarity to the specific content category to be recommended by the content streaming system, and the content category with the high similarity may be determined based on comparison between the similarity and a threshold.

According to an embodiment of the present disclosure, obtaining higher domain information on at least one of a user or an item of a higher domain including the target domain, generating a cross-domain-based factorization machine (FM) model for the higher domain, and performing learning by inputting the higher domain information and the auxiliary domain information into the cross-domain-based FM model for the higher domain may further be included. The obtaining of the target domain information may include obtaining the target domain information by filtering the higher domain information according to the target domain, and the generating of the cross-domain-based FM model may further include generating the cross-domain-based FM model by using a parameter of the learned cross-domain-based FM model for the higher domain and performing learning by inputting the target domain information obtained from the filtered higher domain information into the cross-domain-based FM model.

According to an embodiment of the present disclosure, the performing of the learning by inputting the target domain information obtained from the filtered higher domain information into the cross-domain-based FM model may include fixing a parameter related to a user of the target domain and a parameter related to the auxiliary domain among parameters of the trained FM model for the higher domain, and updating a parameter related to an item of the target domain.

According to an embodiment of the present disclosure, the higher domain information may indicate an identifier of a content of a higher domain, the target domain information may indicate an identifier of a content filtered from the content of the higher domain, and the identifier of the content of the higher domain may be different from the identifier of the filtered content.

According to an embodiment of the present disclosure, the cross-domain-based FM model may include a first order interaction module for generating a first order interaction value of features from the target domain information and the auxiliary domain information, a second order interaction module for generating a second order interaction value of features from the target domain information and the auxiliary domain information, and an output module for outputting a prediction value for the target domain from the first order interaction value and the second order interaction value.

According to an embodiment of the present disclosure, the first order interaction module may include a user first order interaction module for generating an embedded vector from a user parameter for the target domain and generating a first order interaction value for a user feature from the embedded vector, an item first order interaction module for generating an embedded vector from an item parameter for the target domain and generating a first order interaction value for an item feature from the embedded vector, an auxiliary domain first order interaction module for generating an embedded vector from at least one parameter of a user or an item for the auxiliary domain and generating a first order interaction value for an auxiliary domain feature from the embedded vector, and a first order interaction value calculation module for concatenating the first order interaction value for the user feature, the first order interaction value for the item feature and the first order interaction value for the auxiliary domain feature and generating a first order interaction value of the features from the concatenated values. The second order interaction module may include a user second order interaction module for generating a factor dimensional embedded vector from the user parameter for the target domain and generating a second order interaction value for a user feature from the factor dimensional embedded vector, an item second order interaction module for generating a factor dimensional embedded vector from the item parameter for the target domain and generating a second order interaction value for an item feature from the factor dimensional embedded vector, an auxiliary domain second order interaction module for generating a factor dimensional embedded vector from at least one parameter of a user or an item for the auxiliary domain and generating a second order interaction value for an auxiliary domain feature from the factor dimensional embedded vector, and a second order interaction value calculation module for concatenating the second order interaction value for the user feature, the second order interaction value for the item feature and the second order interaction value for the auxiliary domain feature and generating a second order interaction value of the features.

According to an embodiment of the present disclosure, the prediction value indicates a complete watch rate, and the learning may include updating a parameter through comparison between a prediction value and a complete watch rate of training data.

According to an embodiment of the present disclosure, the target domain may include a movie content, and the auxiliary domain may include a broadcast program content.

According to an embodiment of the present disclosure, a method for recommending a content in a content streaming system may include obtaining domain information related to a content, inputting the obtained domain information into a cross-domain-based factorization machine (FM) model, generating a content preference of a target domain by using the cross-domain-based FM model, and providing a per-user personalized recommendation based on the generated content preference of the target domain. The cross-domain-based FM model may be generated based on target domain information and auxiliary domain information related to at least one of a user or a content.

According to an embodiment of the present disclosure, the domain information may include information indicating a genre or a keyword of a content.

According to an embodiment of the present disclosure, the inputting of the obtained domain information into the cross-domain-based FM model may include determining one model among a plurality of cross-domain-based FM models for the target domain based on the information indicating the genre or the keyword of the content and inputting the obtained domain information into the determined one FM model. The generating of the content preference of the target domain by using the cross-domain-based FM model may include generating a content preference for the genre or the keyword of the content, and the obtained domain information may include at least one of information on an item corresponding to the genre or the keyword, information on a user, and information on an auxiliary domain.

According to an embodiment of the present disclosure, the providing of the per-user personalized recommendation may include generating a new interface for content recommendation based on the generated content preference of the target domain.

According to an embodiment of the present disclosure, a device for recommending a content in a content streaming system may include a memory configured to store information necessary for operating the device and a processor coupled with the memory, and the processor may be configured to obtain target domain information related to at least one of a user or an item, obtain auxiliary domain information related to at least one of a user or an item, generate a cross-domain-based factorization machine (FM) model, and perform learning by inputting the target domain information and the auxiliary domain information into the cross-domain-based FM model.

According to the present disclosure, a method and device for content recommendation in a content streaming system may be provided.

According to the present disclosure, a content may be recommended based on a cross-domain-based factorization machine (FM) model in a content streaming system.

According to the present disclosure, the cold-start problem may be solved by using a cross-domain-based FM model.

According to the present disclosure, an interface for content recommendation may be efficiently generated by using a cross-domain-based FM model.

### DESCRIPTION OF THE DRAWINGS

FIG. 1 illustrates a contents streaming system according to an embodiment of the present disclosure.

FIG. 2 illustrates a structure of a client device according to an embodiment of the present disclosure.

FIG. 3 illustrates a structure of a server according to an embodiment of the present disclosure.

FIG. 4 illustrates the concept of a contents streaming service according to an embodiment of the present disclosure.

FIG. 5 illustrates a learning structure in cross-domain according to an embodiment of the present disclosure.

FIG. 6 illustrates a new band generation structure for content recommendation according to an embodiment of the present disclosure.

FIG. 7 is a graph showing watch counts according to an embodiment of the present disclosure.

FIG. 8 is a graph showing watch density of users in each domain according to an embodiment of the present disclosure.

FIGS. 9A and 9B are graphs showing the number of users and the number of items in each learning duration according to an embodiment of the present disclosure.

FIG. 10 illustrates a structure of a cross-domain-based FM model according to an embodiment of the present disclosure.

FIG. 11 is a view illustrating a 2-step learning structure according to an embodiment of the present disclosure.

FIG. 12 illustrates a flowchart of learning of a cross-domain-based FM model according to an embodiment of the present disclosure.

FIG. 13 illustrates a flowchart of 2-step learning of a cross-domain-based FM model according to an embodiment of the present disclosure.

FIG. 14 illustrates a flowchart of a method for content recommendation using a cross-domain-based FM model according to an embodiment of the present disclosure.

### DETAILED DESCRIPTION

Hereinafter, embodiments of the present disclosure will be described in detail with reference to the accompanying drawings so that those skilled in the art can easily carry out the present disclosure. However, the present disclosure may be embodied in many different forms and is not limited to the embodiments set forth herein.

In describing the embodiments of the present disclosure, a detailed description of known configurations or functions will be omitted when it may obscure the subject matter of the present disclosure. In the drawings, parts not related to the description of the present disclosure are omitted, and similar reference numerals denote similar parts.

The functional blocks shown in the drawings and described below are only examples of possible implementations. Other functional blocks may be used in other implementations without departing from the spirit and scope of the detailed description. Additionally, although one or more functional blocks of the present disclosure are represented as separate blocks, one or more of the functional blocks of the present disclosure may be a combination of various hardware and software configurations that perform the same function.

In addition, the expression of including certain components is an expression of “open type” and simply indicates that the corresponding components are present, and should not be understood as excluding additional components. Furthermore, when a component is referred to as being “connected” or “coupled” to another component, it should be understood that it may be directly connected or coupled to the other component or intervening components may also be present.

In addition, a singular expression for an object may be understood as a plural expression, unless the context clearly indicates otherwise. In the present disclosure, expressions such as “A or B” or “at least one of A and/or B” may be understood to include all possible combinations of the items listed together. Expressions such as “first”, “second”, and “third” may modify the object regardless of order or importance, and are used only to distinguish one object from other objects of the same kind.

In addition, in the present disclosure, “configured to” may be understood as having the meaning technically equivalent to any one of expressions of “suitable for”, “having the ability to”, “changed to”, “made to”, “capable of” and “designed to” in terms of hardware or software, depending on the situation, and may be replaced with each other.

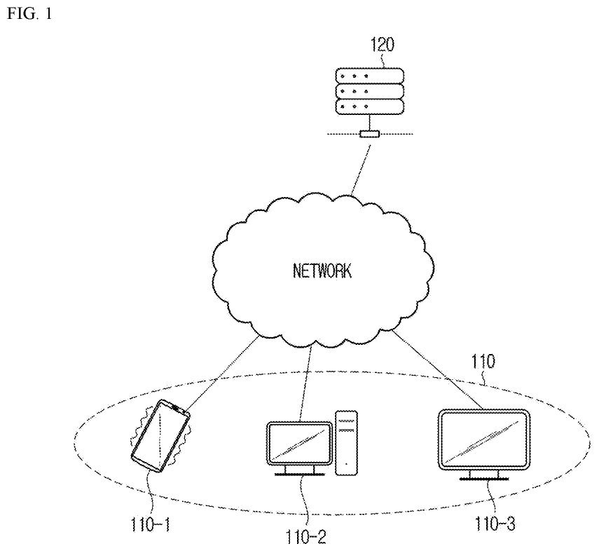

FIG. 1 illustrates a contents streaming system according to an embodiment of the present disclosure. FIG. 1 illustrates a system for providing services related to content, such as content streaming and content-related information provision, and entities belonging to the system. Hereinafter, in the present disclosure, various services related to content may be referred to as ‘content service’ or other terms having equivalent technical meaning.

Referring to FIG. 1, the contents streaming system may include a client device 110 and a server 120. Here, the client device 110 is illustrated as a set of three client devices 110-1 to 110-3, but the contents streaming system may include two or less or four or more client devices. In addition, although one server 120 is illustrated, the contents streaming system may include a plurality of servers that share various functions and interact with each other.

The client device 110 receives and displays content. The client device 110 may receive content streamed from the server 120 after accessing the server 120 through a network. That is, the client device 110 is hardware on which client software or applications designed to use the content service provided by the server 120 are installed, and may interact with the server 120 through the installed software or applications. The client device 110 may be implemented as various types of devices. For example, the client device 110 may be one of a movable portable device, a device that is movable but generally fixed during use, and a device that is fixedly installed at a specific location.

Specifically, the client device 110 may be implemented in the form of at least one of a smartphone 110-1, a desktop computer 110-2, a tablet PC, a laptop PC, a netbook computer, a workstation, a server, a personal data assistant (PDA), a portable multimedia player (PMP), a camera, or a wearable device. Here, the wearable device may be implemented in the form of at least one of an accessory type (e.g., watch, ring, bracelet, anklet, necklace, glasses, contact lens, HMD (head-mounted-device)), clothing type, body attachment type (e.g., skin pad or tattoo), or bio implantable circuit. In addition, the client device 110 is a home appliance, and may be, for example, implemented in the form of at least one of a television 110-3, a digital video disk (DVD) player, an audio system, a refrigerator, an air conditioner, a vacuum cleaner, an oven, a microwave oven, a washing machine, or an air purifier.

The server 120 performs various functions to provide content services. In other words, the server 120 may provide services related to content streaming and various contents to the client device 110 using various functions. Specifically, the server 120 may perform datafication to stream content, and transmit the content to the client device 110 through a network. To this end, the server 120 may perform at least one of content encoding, data segmentation, transmission scheduling, or streaming transmission. Additionally, for the convenience of content use, the server 120 may further perform at least one function of providing a content guide, managing a user's account, analyzing a user preference, or recommending content based on preference. A plurality of functions among the various functions described above may be provided, and for this purpose, the server 120 may be implemented as a plurality of servers.

The client device 110 and the server 120 exchange information through a network, and a content service may be provided to the client device 110 based on the exchanged information. In this case, the network may be a single network or a combination of various types of networks. The network may be understood as a form in which different types of networks are connected according to regions. For example, the networks may include at least one of a wireless network or a wired network. Specifically, the networks include a cellular network based on at least one of 6th generation (6G), 5th generation (5G), long term evolution (LTE), LTE Advance (LTE-A), code division multiple access (CDMA), wideband CDMA (WCDMA), and universal mobile telecommunications system (UMTS), wireless broadband (WiMAX), or Global System for Mobile Communications (GSM). Also, the networks may include a local area network based on at least one of a wireless local area network (WLAN), Bluetooth, Zigbee, near field communication (NFC), or ultra wideband (UWB). In addition, the networks may include wired networks such as the Internet and Ethernet.

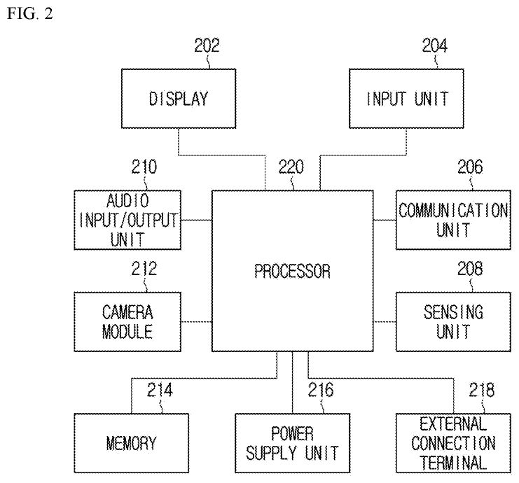

FIG. 2 illustrates a structure of a client device according to an embodiment of the present disclosure. FIG. 2 illustrates a block structure of a client device (e.g., the client device 110 of FIG. 1).

Referring to FIG. 2, the client device includes a display 202, an input unit 204, a communication unit 206, a sensing unit 208, an audio input/output unit 210, a camera module 212, a memory 214, a power supply unit 216, an external connection terminal 218 and a processor 220. However, depending on the type of device, at least one of the components illustrated in FIG. 2 may be omitted.

The display 202 outputs information such as visually recognizable images and graphics. To this end, the display 202 may include a panel and a circuit for controlling the panel. For example, the panel may include at least one of a liquid crystal display (LCD), a light emitting diode (LED), a light emitting polymer display (LPD), an organic light emitting diode (OLED), an active matrix organic light emitting diode (AMOLED) or a flexible LED (FLED).

The input unit 204 receives input generated by a user. The input unit 204 may include various types of input sensing units. For example, the input unit 204 may include at least one of a physical button, a keypad or a touch pad. Alternatively, the input unit 204 may include a touch panel. When the input unit 204 includes a touch panel, the input unit 204 and the display 202 may be implemented as one module.

The communication unit 206 provides an interface for enabling a client device to form a network with other devices and to transmit or receive data through the network. To this end, the communication unit 206 may include a circuit for physically processing signals (e.g., an encoder/decoder, a modulator/demodulator, a radio frequency (RF) front end, etc.), a protocol stack for processing data according to communication standards (e.g., modem), etc. According to various embodiments, the communication unit 206 may include a plurality of modules to support a plurality of different communication standards.

The sensing unit 208 collects sensing data including data on the state of the client device or the surrounding environment. For example, the sensing unit 208 may measure a physical value or a change in value related to an operating state or posture of the client device, and generate an electrical signal representing the measured result. In addition, the sensing unit 208 may measure a physical value or a change in value of the surrounding environment of the client device and generate an electrical signal representing the measured result. To this end, the sensing unit 208 may include at least one sensor and a circuit for controlling the at least one sensor. Specifically, the sensing unit 208 may include at least one of a gyro sensor, a magnetic sensor, an acceleration sensor, a grip sensor, a proximity sensor, a color sensor, a bio sensor, an air pressure sensor, a temperature sensor, a humidity sensor, an illuminance sensor, or an ultra violet (UV) sensor, an e-nose sensor, a gesture sensor, an electromyography (EMG) sensor, an electroencephalogram (EEG) sensor, an electrocardiogram (ECG) sensor, an infrared (IR) sensor, an iris sensor, or a fingerprint sensor.

The audio input/output unit 210 outputs sound according to electrical signals generated based on audio data and detects external sound. That is, the audio input/output unit 210 may convert sound and electrical signals into each other. To this end, the audio input/output unit 210 may include at least one of a speaker, a microphone, or a circuit for controlling them.

The camera module 212 collects data for generating images and videos. To this end, the camera module 212 may include at least one of a lens, a lens driving circuit, an image sensor, a flash, or an image processing circuit. The camera module 212 may collect light through the lens and generate data expressing color values and luminance values of light using the image sensor.

The memory 214 may store an operating system, programs, applications, commands, setting information and the like necessary to operate the client device. The memory 214 may temporarily or non-temporarily store data. The memory 214 may include a volatile memory, a non-volatile memory, or a combination of the volatile and non-volatile memory.

The power supply unit 216 supplies power necessary for the operation of components of the client device. To this end, the power supply unit 216 may include a converter circuit that converts power into power with a magnitude required by each component. The power supply unit 216 may depend on an external power source or may include a battery. In the case of including the battery, the power supply unit 216 may further include a circuit for charging. The circuit for charging may support wired charging or wireless charging.

The external connection terminal 218 is a physical connection unit for connecting the client device to another device. For example, the external connection terminal 218 may include at least one of terminals of various standards, such as a universal serial bus (USB) terminal, an audio terminal, a high definition multimedia interface (HDMI) terminal, a recommended standard-232 (RS-232) terminal, an infrared terminal, an optical terminal, or a power terminal.

The processor 220 controls the overall operation of the client device. The processor 220 may control operations of other components and perform various functions using other components. For example, the processor 220 may also request content data from the server through the communication unit 206 and receive the content data. Also, the processor 220 may restore content by decoding the received content data. Also, the processor 220 may output content received from the server through the display 202 and the audio input/output unit 210. In addition, the processor 220 may control a state related to reproduction of content based on information input or sensed by at least one of the input unit 204, the communication unit 206, the sensing unit 208, the audio input/output unit 210, the camera module 212, the power supply unit 216, and the external connection terminal 218. To this end, the processor 220 may include at least one of at least one processor, at least one microprocessor, or at least one digital signal processor (DSP). In particular, the processor 220 may control other components and perform necessary operations so that the client device operates according to various embodiments described below.

In the structure of the client device described with reference to FIG. 2, all components are illustrated as being connected to the processor 220. Although not shown in FIG. 2, at least some of the components may be connected through a bus. In this case, under the control of the processor 220, direct data exchange may be made between some components.

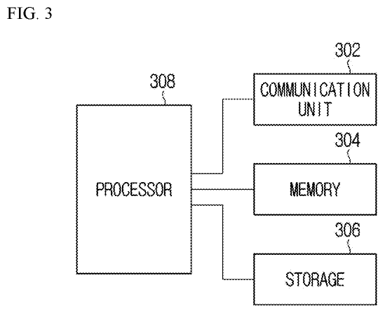

FIG. 3 illustrates a structure of a server according to an embodiment of the present disclosure. FIG. 3 exemplifies a block structure of a server (the server 120 of FIG. 1).

Referring to FIG. 3, the server includes a communication unit 302, a memory 304, a storage 306, and a processor 308. However, according to various embodiments, at least one of the components illustrates in FIG. 3 may be omitted.

The communication unit 302 provides an interface for communication of the server with another device. To this end, the communication unit 302 may include a circuit that generates and analyzes a physical signal for communication. The interface provided by the communication unit 302 may support wired communication or wireless communication.

The memory 304 may store various types of information, an order and/or information and load a computer program, an instruction, and the like stored in the storage 306. The memory 304 may temporarily store data and an instruction for an operation of the server and include a random access memory (RAM). Alternatively, the memory 304 may include various storage media.

The storage 306 may non-temporarily store an operation system for operating the server, a program for performing a function of the server, setting information for an operation of the server, and the like. For example, the storage 306 may include at least one of a non-volatile memory such as a read only memory (ROM), an erasable programmable ROM (EPROM), an electrically erasable programmable ROM (EEPROM), and a flash memory, a hard disk, a removable disc, a solid state drive (SSD), or any form of computer-readable recording medium widely known in the art to which the present disclosure belongs.

The processor 308 controls an overall operation of the server. The processor 308 may control operations of other components and perform various functions using other components. The processor 308 may include at least one of a central processing unit (CPU), a micro processor unit (MPU), a micro controller unit (MCU), or a well-known form of processor in the art to which the present disclosure belongs. Particularly, the processor 308 may control other components to enable the server to operate according to various embodiments described below and perform a necessary operation.

In a structure of a client device described with reference to FIG. 3, components are exemplified to be all connected to the processor 308. Although not illustrated in FIG. 3, at least a part of the components may be connected through a bus. In this case, according to control of the processor 308, direct data exchange among some components may be made.

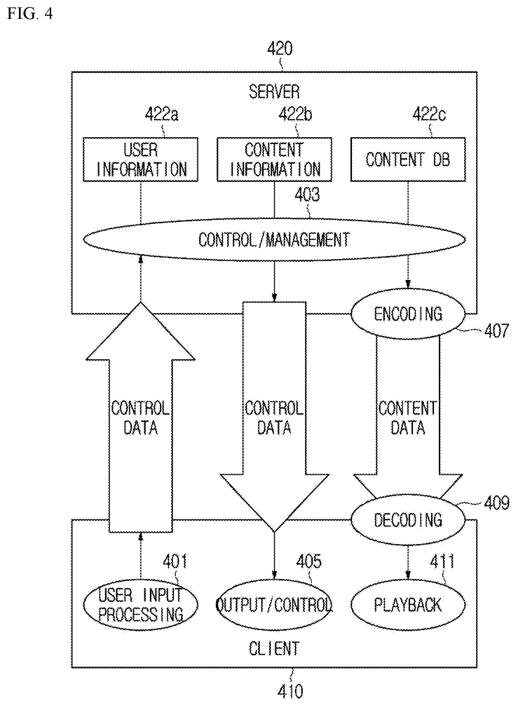

FIG. 4 illustrates a concept of a content streaming service according to an embodiment of the present disclosure. FIG. 4 is a schematic diagram of some functions related to content streaming, and a content streaming service according to various embodiments may have various other functions in addition to the functions illustrated in FIG. 4.

Referring to FIG. 4, control data and content data may be transmitted and received between the client 410 and the server 420. Specifically, transmission of control data from the client 410 to the server 420, transmission of control data from the server 420 to the client 410, and transmission of content data from the server 420 to the client 410 may be performed.

The server 420 stores user information 422a, content information 422b, and content database (DB) 422c. The user information 422a may include user account information, service use history information of users, information about user preferences, and the like. The content information 422b may include a list of serviceable content, content guide information, content meta information, and content consumption history information. The content DB 422c may include content stored in the form of data. In addition to this, the server 420 may further store other information required to provide services.

Control data transmitted from the client 410 to the server 420 may include information on user log-in, information on content selection by the user, information on control of content by the user, and the like. To this end, the client 410 may generate control data from user input through a user input processing operation 401 and transmit it. Control data from the client 410 is processed through a control/management operation 403 and used to provide content. For example, control data and/or content may be selected based on the control data from the client 401 by the control/management operation 403. In addition, preference may be determined by analyzing consumption history and behavior of the user by the control/management operation 403, and content to be recommended may be selected according to the determined preference.

A procedure for providing content to a user will be described with reference to FIG. 4 as follows. First, the client 410 generates control data including log-in information (e.g., ID and password) input by a user through the user input processing operation 301 and transmits the control data. The server 420 determines whether the user is valid by searching the user information 422a for log-in information included in the control data from the client 410, and determines the range of content and services allowed according to the user's authority. However, if log-in is not required or limited services that may be provided without log-in are supported, the transmission and processing of log-in information may be omitted.

Subsequently, the server 410 extracts content guide information from the content information 422b through the control/management operation 403 and transmits control data including the content guide information to the client 410. The client 410 outputs the content guide information included in the control data and confirms user's selection. The user's selection is transmitted to the server 410 as control data via the user input processing operation 401. Information about the user's selection is processed by the control/management operation 403 and used for selection of content to be streamed. The server 420 searches the content DB 422 for the selected content, compresses and segments the searched content through an encoding operation 407, and transmits content data. The content data may be compressed in advance through the encoding operation 407 and stored. Here, the encoding operation 407 may include not only an operation of compressing an original content image, but also an operation of decoding and then re-compressing content data generated through compression. In this case, compression may be performed based on the resolution, bitrate, and number of frames per second of the content image. When it is compressed and stored in advance, the compression operation is omitted, and the server 420 may perform segmentation on the content data. The content data may be restored through a decoding operation 409 and provided to a user through a playback operation 411. At this time, at least one of various video codecs or various audio codecs may be used for compression. For example, various video codecs include at least one of Moving Picture Experts Group-2 (MPEG-2), H.264 Advanced Video Coding (AVC), H.265 High Efficiency Video Coding (HEVC), H.266 Versatile video coding (VVC), VP8 (Video Processor 8), VP9 (Video Processor 9), AV1 (AOMedia Video 1), DivX, Xvid, VC-1, or Daala.

The audio codecs may include MP3 (MPEG 1 Audio Layer 3), AC3 (Dolby Digital AC-3), E-AC3 (Enhanced AC-3), AAC (Advanced Audio Coding, MPEG 2 Audio), FLAC (Free Lossless Audio Codec), HE-AAC (High Efficiency Advanced Audio Coding), OGG Vorbis, OPUS and the like.

A plurality of content data may be generated in advance by compressing a content image according to various resolutions, bitrates, and the number of frames per second of the image. The client 310 may measure throughput (or bandwidth) and determine a bitrate based on the measured throughput (or bandwidth).

The client 410 may receive information about a plurality of content data from the server 420. The received information may include information representing the bitrate, resolution, number of frames per second, and location of a plurality of content data.

The client 410 may determine at least one of content data based on the bitrate, and determine reproduced content data corresponding to the resolution and number of frames per second that may be reproduced among the at least one content data based on the capability information of the client 410, and its location. In this case, the capability information may include the maximum support resolution and the maximum number of supported frames of the client, but is not limited thereto.

The client 410 may transmit a content request to the server 420 based on the location of reproduced content data. The server 420 may transmit content data corresponding to the content request to the client 410 based on the received content request.

According to another embodiment, the client 410 may receive user input related to at least one of the resolution or number of frames per second of the image, determine the reproduced content data and its location according to the user input, and transmit the content request to the server 420.

Hereinafter, a method and device for content recommendation according to the present disclosure will be described. According to the present disclosure, a cross-domain-based factorization machine (FM) model may be used to recommend a specific content. Herein, the FM model may be used to solve the cold-start problem. In addition, the FM model may be used to reduce a man hour when generating a band for recommending a new content.

The cross-domain may mean information exchange between different domains. Alternatively, the cross-domain may mean an information exchange method between different domains. The cross-domain-based FM model may receive various information as input in virtue of its structure and easily replace input data.

### FM (Factorization Machine) Model

An FM model is a machine learning method and is similar to matrix factorization, SVD++, FPMC and the like, but the FM model may further expand input data. For example, when users' preferences of movie are being predicted, existing models may perform learning by using only an ID of a movie content and related information (e.g., a watch time, a review score, etc.). On the other hand, an FM model may perform learning by using not only an ID of a movie content and related information but also additional information such as information on the users' ages and information related to contents that they previously watched.

An FM model may operate well also in an environment with sparse information available for content recommendation. That is, the FM model may not have a negative effect on learning even in an environment with sparse information on a specific feature (e.g., a user's age). In addition, the FM model may also operate well with an input of unobserved interaction. This may be possible because a formula of the FM model includes a part that grasps an interaction between variables.

### Cross-Domain Recommendation

Cross-domain may be a method of using information on another domain (hereinafter, referred to as ‘auxiliary domain’) for a target domain. Herein, a domain may be a specific subject, an area, a field and the like and mean the feature and property of data or knowledge. As cross-domain utilizes an auxiliary domain, it may be applied to an FM model capable of expanding input data. Cross-domain may effectively solve the cold-start problem since it is capable of abundantly supplementing a poor pool available in an FM model.

Herein, the cold-start problem may mean a problem in that when a user has sparse information on a target domain, learning the user properly is not possible and thus recommendation is very difficult. A user with such a problem may be called a cold starter. Cross-domain may inject abundant auxiliary information into a cold starter with sparse information. Accordingly, if cross-domain is used, the scope of the cold starter may be reduced.

When a large amount of new contents are put into a content streaming system, an existing content streaming system is designed to expose only popular contents, and thus there may be a problem in that consumption is excessively biased towards those popular contents. However, if cross-domain is used, a content streaming system may perform personalized recommendation for new contents. That is, according to individual watch patterns, different and various contents may be recommended or exposed. Accordingly, according to an embodiment of the present disclosure, a content streaming system may recommend a new content to a user by using a cross-domain application method.

To perform learning by using cross-domain, a model for learning a user parameter and an item parameter may be constructed. Herein, the model for learning a user parameter and an item parameter may be constructed according to each domain. For example, a content streaming system for content recommendation may construct a model learned based on contents of the action genre and a model learned based on contents of the SF genre, respectively. In this case, since the features of a user and an item may be different according to each domain, features of domains may be modeled more accurately. That is, as optimization is possible according to each domain, better prediction performance may be expected.

Herein, the user parameter may be information on a user. For example, the user parameter may be a unique ID or index for identifying a user. In addition, the item parameter may be content-related information such as the genre of a content. For example, the item parameter may be an ID or index for indicating the genre of a content, or the item parameter may be an ID or index for identifying the content. However, the present disclosure is not limited thereto, and the item parameter may include various content-related information.

According to the present disclosure, an auxiliary domain used for learning of an FM model may be related to a target domain. For example, in the case of movie recommendation, a target domain may be a movie. In this case, a suitable auxiliary domain candidate may be an interaction for a (broadcast) program or a user's profile information.

However, if dependence on an auxiliary domain is great, learning or inference may be governed by the auxiliary domain. That is, multicollinearity may be problematic. Herein, multicollinearity means a phenomenon that a prediction variable of a model used for analysis is so highly correlated with another prediction variable as to have a negative effect on data analysis. As an example of the present disclosure, when there is a high interaction between auxiliary domains, there may be a problem in that the other similar domain is not properly learned. In this case, a content streaming system may set a domain, which is consistently provided in learning or inference or is dense, as an auxiliary domain.

A cross-domain-based FM model according to the present disclosure may solve the cold start problem by using an entire watch record with relatively dense data. That is, even when numerous movie or (broadcast) program contents present in a content streaming system have a low record of watch, the content streaming system may efficiently recommend a new content.

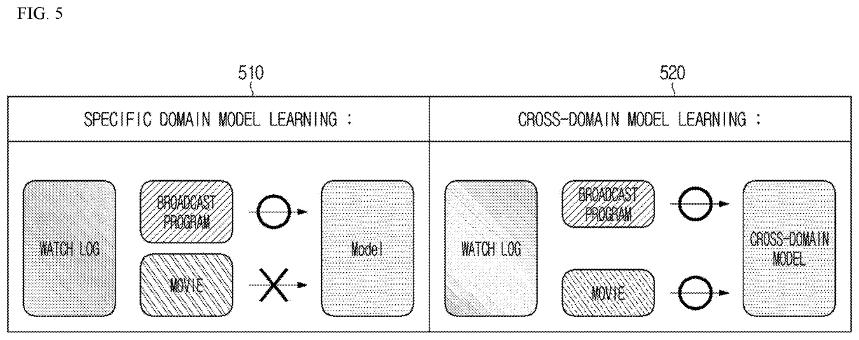

FIG. 5 illustrates a learning structure in cross-domain according to an embodiment of the present disclosure. FIG. 5 illustrates an example in which the movie is set as a target domain and the broadcast program is set as an auxiliary domain. A left box 510 illustrates an existing learning structure (specific domain model learning structure), and a right box 520 illustrates a cross-domain-based learning structure (cross-domain model learning structure). When there is no watch record for a target domain, an existing model does not consider an interaction between the target domain and an auxiliary domain, and thus the cold start problem may increase. That is, as information loss occurs due to a sparse interaction in the target domain, the cold start problem may increase.

On the other hand, in the case of a cross-domain-based FM model, a content streaming system may perform learning for a target domain by using information on users with watch records for an auxiliary domain with high similarity, even when there is no watch record for the target domain. Accordingly, as a new content may be efficiently recommended to users having no watch record for a target domain, the cold start problem may be solved. That is, the cold start problem may be solved by using a watch pattern related to an auxiliary domain of recommendable users as auxiliary information, while reducing the loss of information.

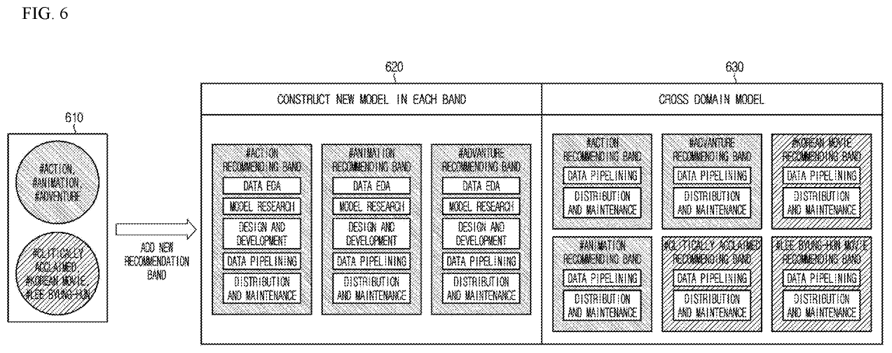

FIG. 6 illustrates a new band generation structure for content recommendation according to an embodiment of the present disclosure. Herein, a ‘band’ may be an interface for content recommendation according to each domain. According to the present disclosure, by using a cross-domain-based FM model, a content streaming system may generate a new band for recommending a personalized content more efficiently than an existing model. A content streaming system may receive various input features 610 to construct a new model or a cross-domain-based FM model. Herein, the various input features 610 may include information on a domain, information on a content, information on a user, and the like.

When a new model is constructed according to each domain (620), a development man-hour burden may increase because data exploratory data analysis (EDA), model research, design and development should be performed for each domain. On the other hand, when a cross-domain-based FM model is constructed (630), a content streaming system may quickly add a band for each domain, and efficient maintenance may be possible through model uniformity. That is, a development man-hour burden may decrease because data EDA, model research, design and development need not be performed for each domain.

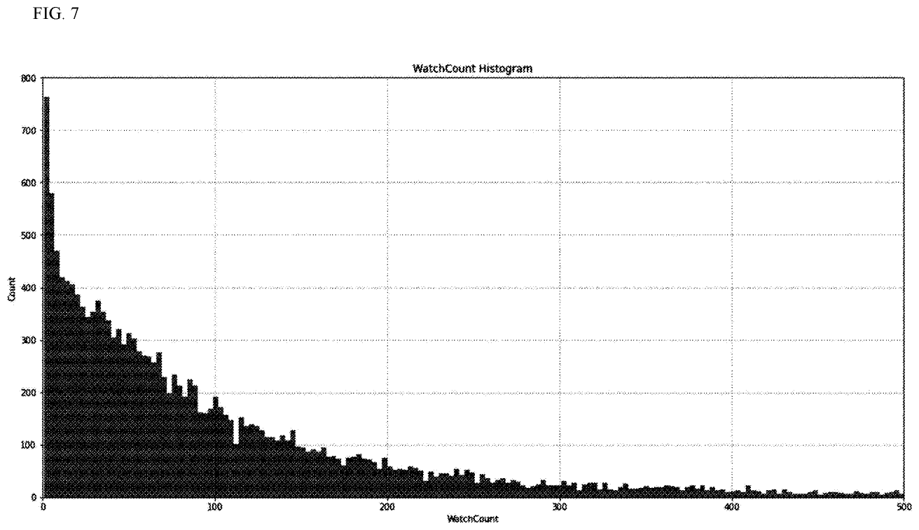

Specifically, when a cross-domain-based FM model is used to generate a new band, an input feature may be easily replaced and expanded. That is, a cross-domain-based FM model may be convenient for a task of adding a new feature or replacing an existing feature, even when the structure or parameter of the model is not modified. Accordingly, by using an FM model, a new band may be generated to constitute and replace a class in charge of each pool, and a cross-domain-based FM model may be constructed for easy replacement in relation to a model for constructing a class for each domain. Hereinafter, a cross-domain-based FM model according to the present disclosure will be described with reference to FIG. 7 to FIG. 11. An FM model mentioned in the present disclosure may include a DeepFM model.

FIG. 7 is a graph showing watch counts according to an embodiment of the present disclosure. FIG. 7 may show a distribution of cold starters through analysis of watch counts of each user. In the graph of FIG. 7, the horizontal axis may show watch counts, and the vertical axis may show the number of users. FIG. 7 shows there are only a few users with high watch counts. That is, the graph of FIG. 7 may mean that there are a lot of cold starters. As the graph of FIG. 7 is based on watch records for every content, it may mean that every domain has a lot of cold starters.

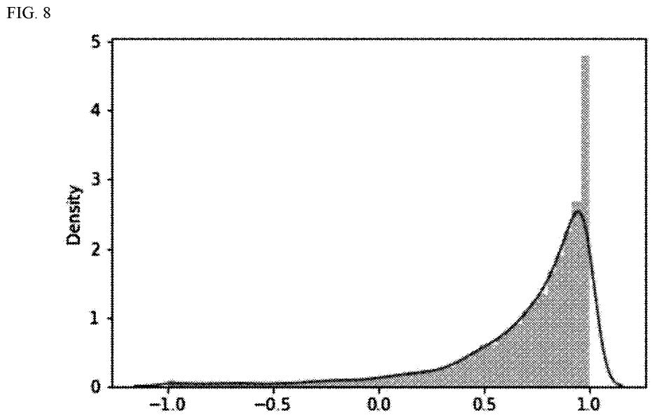

FIG. 8 is a graph showing watch density of users in each domain according to an embodiment of the present disclosure. FIG. 8 is a graph analyzing watch density of users in each domain when movies are set as a target domain and broadcast programs are set as an auxiliary domain. In the graph of FIG. 8, when the horizontal axis is closer to −1.0, it may mean that watch density for the target domain becomes higher, and when the horizontal axis is closer to 1.0, it may mean that watch density for the auxiliary domain becomes higher. Through the graph of FIG. 8, it may be seen that most users are much biased towards the auxiliary domain. That is, it may be confirmed that the target domain has a relatively smaller share than the auxiliary domain. In this case, the present disclosure may use a cross-domain-based FM model to use information on the auxiliary domain with a relatively larger share for recommending a specific content with a relatively smaller share.

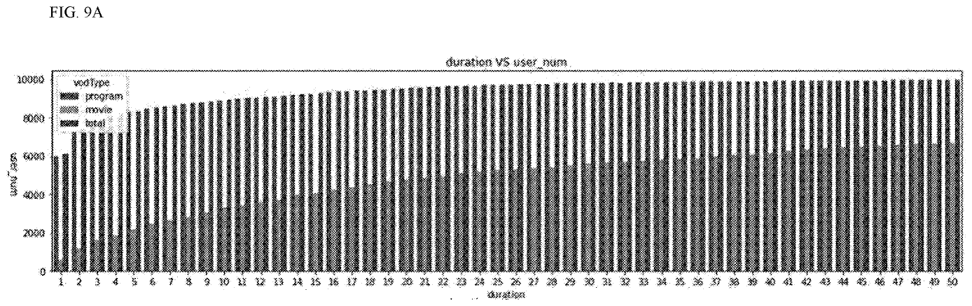

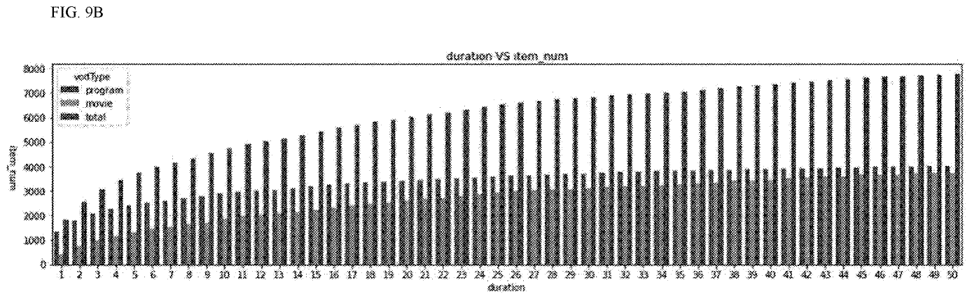

FIGS. 9A and 9B are graphs showing the number of users and the number of items in each learning duration according to an embodiment of the present disclosure. Referring to FIGS. 9A and 9B, after a specific time, the increase in the total number of user or items is reduced. Accordingly, to efficiently learn a cross-domain-based FM model, a content streaming system may determine a learning duration by using a specific threshold. Alternatively, the content streaming system may perform learning for a learning duration that is arbitrarily determined.

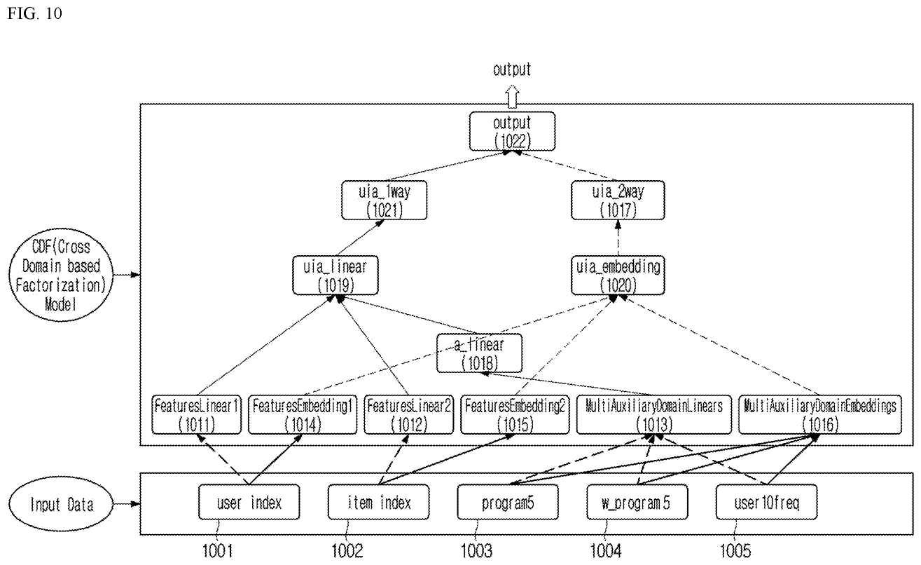

FIG. 10 illustrates a structure of a cross-domain-based FM model according to an embodiment of the present disclosure. The cross-domain-based FM model may receive input data 1001, 1002, 1003, 1004 and 1005. Herein, the input data may include at least one of the user index 1001, the item index 1002, program5 1003, w_program5 1004 or user10freq 1005. program5 1003 may be data indicating 5 items (contents) that a user has watched recently. program5 1003 may be data indicating content complete watch rates for the 5 recently watched items (contents) of the user. user10freq 1005 may be data indicating whether a user is a heavy user. An item that a user has watched recently may include a target domain content and/or an auxiliary domain content.

The user index 1001 may be an identifier (ID) or an index identifying a user, and each user may have a different ID or index. In addition, the item index 1002 may be an identifier (ID) or an index identifying an item (content), and each item may have a different ID or index. For example, if a specific genre A has a total of 500 contents, the range of IDs or indexes of the contents in the genre A may be 0 to 499.

program5 1003 may be a set of 5 contents that a user has watched recently. As an ID or index of a content may be different in a target domain and an auxiliary domain, data about 5 contents, which a user has most recently watched, may be a value limited to the auxiliary domain. By performing learning only by the 5 contents that the user has most recently watched, a similarity to a new content may be prevented from being lowered by a content that is watched long before.

w_program5 1004 is a value indicating a preference for a specific content and may be expressed by a value between 0 and 1. For example, in the case of a movie content, a complete watch rate may be {(watch time)/(running time)}, and in the case of a broadcast program, a complete watch rate may be an average value of {(watch time)/(running time)} of each episode but is not limited thereto.

user10freq 1005 may be an indicator for determining whether a user is a heavy user. user10freq 1005 may have a value ranging from 0 to 10. Whether a user is a heavy user may be determined based on a target domain and an auxiliary domain. That is, a heavy user may be determined based on an entire domain.

According to an embodiment of the present disclosure, a cross-domain-based FM model may perform learning through comparison between a complete watch rate and a prediction value. Herein, the complete watch rate may be a value for determining a user's preference, but the present disclosure is not limited thereto and may use various types of information capable of determining a user's preference. A complete watch rate of 0.8 or above may mean completion of watch to the effect that an entire content is actually watched except the opening and credits of the content.

Specifically, a cross-domain-based FM model may perform learning by using an embedding vector indicating a corresponding user and an embedding vector indicating a corresponding item. As learning for embedding representing an item of a corresponding user is not performed yet at its initial stage, the cross-domain-based FM model may perform learning for the user's content preference by using a complete watch rate as a label. The cross-domain-based FM model may adjust a weight by using the complete watch rate and a prediction value predicted by the FM model.

According to an embodiment of the present disclosure, a complete watch rate may be calculated by a user's watch time and a running time of a content. The “complete watch rate” described herein is not a subjective human evaluation, but a quantifiable, objective machine metric physically measured and tracked by the content streaming system, calculated automatically as a ratio of a chronologically logged watch time to a total running time of the specific media file. Herein, the model may be learned well only when a process of reading a content running time is well operated. There may be 3 reference methods for reading a content running time. First, a content streaming system may use an oracle_tcm*table. Specifically, the content streaming system may obtain a running time by using the oracle_tem_*table. A running time of a content may be obtained by going through the following 4 tables.

Among the 4 tables, a lower one may include more detailed information, and thus a lower value is more likely to be used as a running time than a higher value, but the present disclosure is not limited thereto.
oracle_tcm_program: provides a running time for a program. As a complete watch rate is calculated for each episode, a running time of a program, which is not an episode, may be calculated less accurately.
oracle_tcm_movie: provides a running time for a movie.
oracle_tcm_episode: provides a running time for an episode.
oracle_tcm_vod_file: provides a running time for each VOD file.

Second, when no running time is provided for a reason, a running time from episodes with different running times may be used. That is, a running time may be obtained by using a medium value of episodes with different running times in a same program. Third, when there is a small number of episodes, a medium value may be inaccurate. In this case, information on a watch pattern may be used. In a watchlog table, a running time may be obtained from a 98th quantile. That is, if all the viewers of a single content are listed in ascending order of watch duration, a watch duration of top 2% may be obtained. In the case of 99th to 100th quantiles, there may be an outlier because a watch record keeps being added for a reason after watch is completed, and thus the case of 99th to 100th quantiles may be excluded. However, the above-described reference quantile is merely one example, and a different value may be adopted.

Modules used in the cross-domain-based FM model of FIG. 10 may be as follows.
FeaturesLinear1 module 1011
FeaturesLinear2 module 1012
MultiAuxiliaryDomainLinears module 1013
FeaturesEmbedding1 module 1014
FeaturesEmbedding2 module 1015
MultiAuxiliaryDomainEmbeddings module 1016
uia_2way module 1017
a_linear module 1018
uia_linear module 1019
uia_embedding module 1020
uia_1way module 1021
output module 1022

The FeaturesLinear1 module 1011 and the FeaturesLinear2 module 1012 may model a linear relation of each feature. Specifically, the FeaturesLinear1 module 1011 may receive a user index as input. The FeaturesLinear1 module 1011 may obtain a user first order interaction value (user_linear) based on the input user index. That is, the FeaturesLinear1 module 1011 may obtain a user first order interaction value of a scalar. The FeaturesLinear1 module 1011 may obtain a user first order interaction value and model a linear relation for a feature of a user by reflecting the user first order interaction value in a prediction of a model.

The FeaturesLinear2 module 1012 may receive an item index as input. The FeaturesLinear2 module 1012 may obtain an item first order interaction value (item_linear) based on the input item index. That is, the FeaturesLinear2 module 1012 may obtain an item first order interaction value of a scalar.

An item first order interaction value may be a linear weight indicating a feature of an item. A linear weight indicating a feature of an item may be a value indicating a degree of effect that the feature of the item has on prediction of a model. The FeaturesLinear2 module 1012 may obtain an item first order interaction value and model a linear relation for a feature of an item by reflecting the item first order interaction value in prediction of a model.

A first order interaction value of the FeaturesLinear1 module 1011 and the FeaturesLinear2 module 1012 may be obtained by receiving an embedding vector of an input index (user index and/or item index) and then adding a dropout and a bias. Herein, the dropout process is one method for preventing overtraining of a neural network and may be a method that randomly selects a specific percentage of nodes and turns off the nodes. Such a dropout process may be a normalization technique of preventing overtraining in a deep neural network structure that is easily subject to overtraining. A bias may be a constant that is added to a product of a weight and an input value in a linear layer of a neural network. That is, a bias may serve to adjust a final output value. Herein, a bias is a value corresponding to w₀ of Formula 1 described below, and this may also be trained.

The MultiAuxiliaryDomainLinears module 1013 may be a module in charge of a linear part for an auxiliary domain. That is, the MultiAuxiliaryDomainLinears module 1013 may consider information on a plurality of auxiliary domains. By considering not only information on a content but also information on various auxiliary domains such as the gender and age of a user and a content genre, a content streaming system may effectively recommend a content.

The MultiAuxiliaryDomainLinears module 1013 may model a linear relation for a plurality of auxiliary domains. In order to model a linear relation for a plurality of auxiliary domains, the MultiAuxiliaryDomainLinears module 1013 may receive indexes and weights of the plurality of the auxiliary domains as input. For example, the MultiAuxiliaryDomainLinears module 1013 may receive at least one of program5, w_program5 or user10freq as input. For example, when the MultiAuxiliaryDomainLinears module 1013 a linear relation for a plurality of auxiliary domains (e.g., program5, w_program5 or user10freq), a different weight may be applied for each of the auxiliary domains. Herein, a weight of each auxiliary domain may be a value indicating a feature or influence of the domain.

The MultiAuxiliaryDomainLinears module 1013 may obtain an auxiliary domain first order interaction value (aux linear) for the input indexes and weights of auxiliary domains. Accordingly, the MultiAuxiliaryDomainLinears module 1013 may output the auxiliary domain first order interaction value (List [Scalar]). Herein, the auxiliary domain first order interaction value is generated as a list, and it is because a plurality of outputs are generated for information inputs for a plurality of auxiliary domains. That is, the output auxiliary domain first order interaction value (List [Scalar]) may include an output value for each input auxiliary domain.

Herein, the generation of the auxiliary domain first order interaction value by the MultiAuxiliaryDomainLinears module 1013 may be performed by bringing an embedding vector list through an input index list value and applying torch.stack. Herein, the list of input indexes may include a value corresponding to at least one auxiliary domain, and in the case of a domain with a weight, the weight and an input index may be included in an input index list, and in the case of a domain without weight, an input index may be included in an input index list.

Herein, torch.stack may mean that two tensors are connected based on a new dimension. For example, when one-dimensional output values with a batch size of 1 are generated for 2 auxiliary domains, if the one-dimensional output values are connected through torch.stack, a list with a size of [1, 2] may be generated. That is, torch.stack may be a process of combining a plurality of output values into a single matrix.

Herein, an auxiliary domain with a weight and an auxiliary domain without weight may have different processing processes. According to the present disclosure, the program5 1003 and the w_program5 1004 may be auxiliary domains with a weight. The user10freq 1005 may be an auxiliary domain without weight. In the case of an auxiliary domain with a weight, a cross-domain-based FM model may bring 5 embedding vectors corresponding to each content included in a program5 index. The cross-domain-based FM model may multiply the 5 embedding vectors thus brought by w_program5 and then calculate an element-wise sum of the 5 vectors. That is, the cross-domain-based FM model may add up the 5 embedding vectors. By adding respective components of one embedding vector thus generated, the cross-domain-based FM model may generate an output value of the MultiAuxiliaryDomainLinears module 1013.

In the case of an auxiliary domain without weight, the cross-domain-based FM model may bring one embedding vector corresponding to a user 10freq index. By adding respective component of the one embedding vector thus brought, the cross-domain-based FM model may generate an output value of a module.

That is, by adding respective component of the one embedding vector thus brought, the cross-domain-based FM model may generate an output value of the MultiAuxiliaryDomainLinears module 1013. Thus, the MultiAuxiliaryDomainLinears module 1013 may perform more accurate prediction by combining information of various domains.

The FeaturesEmbedding1 module 1014 may receive a user index as input. The FeaturesEmbedding1 module 1014 may obtain a user second order interaction value (user_embedding)(vector). Herein, the user second order interaction value may be a value indicating a second order interaction between input features, and a vector may be a factor dimensional vector. The second order interaction may be an interaction according to a combination of input features in an FM model. For example, the second order interaction may be modeling of an interaction when the gender of a user and the genre of a movie occur together.

The FeaturesEmbedding2 module 1015 may receive an item index as input. According to the present disclosure, an item may mean a content. The FeaturesEmbedding2 module 1015 may obtain an item second order interaction value (item_embedding)(vector). The item second order interaction value may be a value indicating a second order interaction between input features.

An item second order interaction value of the FeaturesEmbedding1 module 1014 and the FeaturesEmbedding2 module 1015 may be obtained by bringing an embedding vector of an input index and then performing a dropout process.

The MultiAuxiliaryDomainEmbeddings module 1016 may receive indexes and weights of auxiliary domains as input. The MultiAuxiliaryDomainEmbeddings module 1016 may obtain an auxiliary domain second order interaction value (aux_embedding) for the input indexes and weights of the auxiliary domains. Accordingly, the MultiAuxiliaryDomainEmbeddings module 1016 may output a second order interaction value (List [vector]) of vectors representing the auxiliary domains. Herein, the vectors may be factor dimensional vectors. Herein, the auxiliary domain second order interaction value is generated as a list, and it is because outputs are generated for inputs of information for a plurality of auxiliary domains. That is, the output auxiliary domain second order interaction value (List[Scalar]) may include an output value for each input auxiliary domain. Herein, the second order interaction value of the MultiAuxiliaryDomainEmbeddings module 1016 may be obtained by bringing an embedding vector list through an input index list value and then applying torch.stack.

The a_linear module 1018 may perform a process of concatenating a plurality of values in a list output from the MultiAuxiliaryDomainLinears module 1013. The uia linear module 1019 may perform a process of concatenating values output from the FeaturesLinear1 module 1011, the FeaturesLinear2 module 1012 and the a linear module 1018.

The uia_embedding module 1020 may perform a process of concatenating output values of the FeaturesEmbedding1 module 1014, the FeaturesEmbedding2 module 1015 and the MultiAuxiliaryDomainEmbeddings module 1016.

The uia 2way module (FactorizationMachine module) 1017 may receive a value output from the uia_embedding module 1020 as input. That is, it may receive, as input, a concatenated value of output values of the FeaturesEmbedding1 module 1014, the FeaturesEmbedding2 module 1015 and the MultiAuxiliaryDomainEmbeddings module 1016. The uia_2way module 1017 may obtain, from the input value, a second order interaction value of a user index, an item index and indexes of auxiliary domains. The second order interaction value of the uia_2way module 1017 may be calculated by the third term of Formula 1 below.

$$\hat{y} ( x ) := {w}_{0} + {\sum }_{i = 1}^{n} {w}_{i} {x}_{i} + {\sum }_{i = 1}^{n} {\sum }_{j = i + 1}^{n} < {v}_{i} , {v}_{j} > {x}_{i} {x}_{j} \qquad [ Formula 1 ]$$

In Formula 1, y(x) represents a prediction value of an FM model. w₀ is a bias, which may be a value added in the FeaturesLinear1 module 1011 and the FeaturesLinear2 module 1012. wᵢ is a weight of a linear term and may be a weight applied to xᵢ. xᵢ may mean an i-th feature value of input data x. vᵢ may be an embedding vector of an i-th feature. <vᵢ, vⱼ> may mean an inner product of two embedding vectors vᵢ and vⱼ. xᵢxⱼ may mean a product of two input data features xᵢ and xⱼ.

In Formula 1, the second term is a linear term and may be a process performed in the uia_1way module 1021. Specifically, the uia_1way module 1021 may receive an output value of the uia_linear module 1019 as input and then perform a torch.stack process. The output value of the uia_1way module 1021 may indicate a degree to which each feature linearly contributes to the prediction of a model. In Formula 1, the third term is a process performed in the uia_2way module 1017 and may represent an interaction between different features. That is, the third term of Formula 1 may model a nonlinear relation between features.

A cross-domain-based FM model may derive a final prediction value by finally adding output values of the uia_1way module 1021 and the uia_2way module 1017 in the output module 1022. The final prediction value thus derived may be a content preference (complete watch rate) for a specific user. The cross-domain-based FM model may recommend a content for each user by deriving a prediction value.

Meanwhile, the last term of Formula 1 may be expressed as Formula 2 below, and a second order interaction value may be calculated according to Formula 2. Herein, <vᵢ, vⱼ> is another expression of wᵢⱼ, which may be expressed by a sum of inner products between v_{i,f} and v_{j,f}. wᵢⱼ may represent a weight for an interaction between an i-th feature and a j-th feature.

$$[ Formula 2 ]$$

$$\begin{matrix}{\sum }_{i = 1}^{n} {\sum }_{j = i + 1}^{n} < {v}_{i} , {v}_{j} > {x}_{i} {x}_{j} = \frac{1}{2} {\sum }_{i = 1}^{n} {\sum }_{j = 1}^{n} < {v}_{i} , {v}_{j} > {x}_{i} {x}_{j} - \frac{1}{2} {\sum }_{i = 1}^{n} < {v}_{i} , {v}_{i} > {x}_{i} {x}_{i} \\ = \frac{1}{2} ( {\sum }_{i = 1}^{n} {\sum }_{j = 1}^{n} {\sum }_{f = 1}^{k} {v}_{i , f} {v}_{j , f} {x}_{i} {x}_{j} - {\sum }_{i = 1}^{n} {\sum }_{f = 1}^{k} {v}_{i , f} {v}_{i , f} {x}_{i} {x}_{i} ) \\ = \frac{1}{2} {\sum }_{f = 1}^{k} ( ( {\sum }_{i = 1}^{n} {v}_{i , f} {x}_{i} ) ( {\sum }_{j = 1}^{n} {v}_{j , f} {x}_{j} ) - {\sum }_{i = 1}^{n} {v}_{i , f}^{2} {x}_{i}^{2} ) \\ = \frac{1}{2} {\sum }_{f = 1}^{k} ( {( {\sum }_{i = 1}^{n} {v}_{i , f} {x}_{i} )}^{2} - {\sum }_{i = 1}^{n} {v}_{i , f}^{2} {x}_{i}^{2} )\end{matrix}$$

Formula 2 may be a formula for calculating a second order interaction value by using a sum of inner products of vectors and squares of the vectors for each feature. When the uia_2way module 1017 calculates a vector of a user/item/auxiliary domain instead of a vector (v_{i,f}) for an i-th feature, unlike Formula 2, values reflecting features (or features for each field) for each vector of the user/item/auxiliary domain are output, and thus a value obtained by subtracting a square of final vector elements from a square of the sum of elements of concatenated vectors (K dimensions) may correspond to a value of Formula 2 above. That is, obtaining of a second order interaction value may correspond to calculating the subtraction the square of respective elements from the square of a sum of respective elements. The vector wᵢⱼ of Formula 1 of an FM model may be factorized into an inner product of K-dimensional resolved vectors vᵢ and vⱼ, and here, vᵢ and vⱼ may be vectors resolved in K dimensions. In a sparse environment, variables have such strong independence that an interaction is difficult to detect, and when information on each variable is expressed by a K-dimensional latent vector (factor vector) to break the independence in a latent space, an interaction (second order interaction) may be obtained easily.

As used herein, a “factor dimensional” vector refers to a vector resolved in K dimensions (i.e., a K-dimensional latent vector or factor vector) used to capture latent features and break independence in a sparse environment, as further described with reference to Formula 1 and Formula 2.

As mentioned above, a DeepFM model performs embedding for a first order interaction, and thus sparse vectors (e.g., one-hot vectors) of features of a user and an item of a main domain and features of an auxiliary domain may be transformed into dense vectors of the features and a weight of each feature is also trained so that a product of a weight and a feature may be reflected in an embedded value. This specific transformation from high-dimensional sparse vectors to low-dimensional dense vectors significantly reduces the memory footprint required for storing feature representations, and structurally accelerates matrix multiplication operations within the hardware processor (e.g., GPU or CPU) during the model training and inference phases.

Meanwhile, as described above, when the DeepFM model performs embedding for a second order interaction, sparse vectors of features of a user and an item of a main domain and features of an auxiliary domain may be transformed into dense vectors of the features and latent vectors of each feature may also be trained, so that a product of a latent vector and a feature may be reflected in an embedded value.

In the present disclosure, the term “module” (e.g., the first order interaction module, the second order interaction module, the output module, etc.) refers to a hardware component, such as at least one processor (e.g., the processor 308), executing specific algorithmic instructions. These specific instructions include, but are not limited to, generating embedding vectors, concatenating tensors (e.g., using torch.stack), and calculating interaction values using specific mathematical formulas (e.g., Formula 1 and Formula 2) as detailed herein.

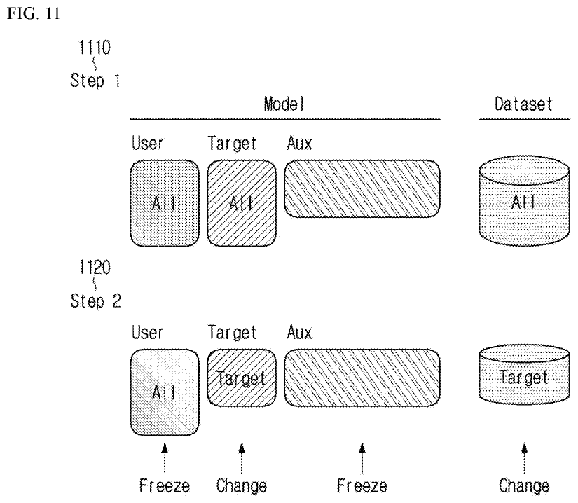

FIG. 11 is a view illustrating a 2-step learning structure according to an embodiment of the present disclosure. At Step 1 (1110), a cross-domain-based FM model may perform first order learning by using a complete watch rate (score) for every content. According to an embodiment of the present disclosure, the cross-domain-based FM model may perform learning by using a complete watch rate through comparison with a prediction value.

Specifically, the cross-domain-based FM model may perform learning by using an embedding vector indicating a corresponding user and an embedding vector indicating a corresponding item. As learning for the user's content preference is not performed yet at its initial stage, the cross-domain-based FM model may perform learning by using a (previously observed) complete watch rate.

At Step 2 (1120), the cross-domain-based FM model may perform learning only for a target domain after fixing the other domains than the target domain. Herein, data of the target domain for relearning may be filtered through a specific logic. Through the filtering, only the target domain excluding an auxiliary domain may remain. For example, if the genre of a content is ‘action’, only data about contents with a same genre may be obtained through filtering.

In addition, for relearning, an embedding space for a target domain may be initialized. Initialization of an embedding space may be a process of setting embedding vectors representing features of the target domain to default values (e.g., meaningless random values) at an initial learning stage of the FM model.

When a 2-step learning strategy is used through initialization of an embedding space, a user parameter optimization problem of a cold starter may be solved. In addition, when the 2-step learning strategy is used, a time required for learning to generate a new band may be saved. When a 1-step learning strategy is used, an FM model has three types of input features, that is, a user, a target item and an auxiliary domain. Herein, the target item and the auxiliary domain may well be learned without problem, while every parameter of a cold start user may not be learned well or may not be learned at all. This may be intuitively understood since a complete watch rate as a score for a target domain is used in learning and a cold starter is a user having no record for the target domain. For specific cold starters, no learning information may be given, and a model parameter for the users may be an initialized arbitrary value even after learning.

Accordingly, at step 1, first order learning is performed using a complete watch rate for every content, and at step 2, only an item parameter in a target domain may be learned by fixing the other parameters than the item parameter in the target domain. Complete cold starter users (having only watch records for an auxiliary domain) also participate in learning, and thus the item parameter may be updated.

Another benefit of the 2-step learning strategy is that a time required for learning may be saved when generating a new band. As only a target domain participates in 2-step learning, 1-step learning is performed beforehand, and 2-step learning is performed for respective new band models so that a time required for learning an existing user and an auxiliary domain may be saved. Furthermore, the 2-step learning strategy utilizing parameter freezing (e.g., fixing parameters related to a user of the target domain and the auxiliary domain) provides a practical application and significant technical improvements to the computer system itself. Specifically, it drastically reduces the computational load on processors, minimizes memory footprint during model updates, and decreases the processing time required for generating cold-start recommendation bands, thereby improving the overall functioning and operational efficiency of the content streaming server.

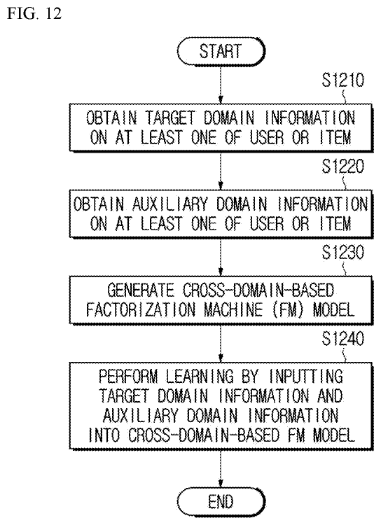

FIG. 12 illustrates a flowchart of learning of a cross-domain-based FM model according to an embodiment of the present disclosure. Referring to FIG. 12, a content streaming system may obtain target domain information on at least one of a user or an item (S1210). Herein, the target domain information may include a user parameter for a target domain and/or an item parameter for the target domain. The user parameter may be a user identifier, and the item parameter may be an item parameter. In addition, the target domain information may include information related to a complete watch rate for a content and/or a genre of a specific content to be recommended by the content streaming system.

The content streaming system may obtain auxiliary domain information on at least one of a user or an item (S1220). Herein, the auxiliary domain information may include a user parameter for an auxiliary domain and/or an item parameter for the auxiliary domain. The user parameter for the auxiliary parameter may include a content use frequency of a user. In addition, the item parameter for the auxiliary domain may include at least one of an identifier of at least one previously watched content and a complete watch rate of the at least one previously watched content. In addition, the auxiliary domain information may include information related to a complete watch rate for a content and/or a similar content to a specific content to be recommended by the content streaming system.

The content streaming system may generate a cross-domain-based FM model (S1230). Herein, the cross-domain-based FM model may include a first order interaction module (e.g., the uia_1way module 1021) for generating a first order interaction (or linear) value of features from the target domain information and the auxiliary domain information, a second order interaction module (e.g., the uia_2way module 1017) for generating a second order interaction value (or interaction value) of features from the target domain information and the auxiliary domain information, and/or an output module (e.g., the output module 1022) for outputting a prediction value for the target domain from the first order interaction value and the second order interaction value. Herein, the prediction value may be a complete watch rate.

The first order interaction module may include a user first order interaction module (e.g., the FeaturesLinear1 1011) for generating an embedded vector from a user parameter for the target domain and generating a first order interaction value for a user feature from the embedded vector. In addition, the first order interaction module may include an item first order interaction module (e.g., the FeaturesLinear2 module 1012) for generating an embedded vector from an item parameter for the target domain and generating a first order interaction value for an item feature from the embedded vector.

In addition, the first order interaction module may include an auxiliary domain first order interaction module (e.g., the MultiAuxiliaryDomainLinears module 1013) for generating an embedded vector from at least one parameter of a user or an item for the auxiliary domain and generating a first order interaction value for an auxiliary domain feature from the embedded vector. In addition, the first order interaction module may include a first order interaction value calculation module (e.g., the uia_linear module 1019, the uia_1way module 1021) for concatenating the first order interaction value for the user feature, the first order interaction value for the item feature and the first order interaction value for the auxiliary domain feature and generating a first order interaction value of the features from the concatenated values.

The second order interaction module may include a user second order interaction module (e.g., the FeatureEmbedding1 module 1014) for generating a factor dimensional embedded vector from the user parameter for the target domain and generating a second order interaction value for a user feature from the factor dimensional embedded vector. In addition, the second order interaction module may include an item second order interaction module (e.g., the FeatureEmbedding2 module 1015) for generating a factor dimensional embedded vector from the item parameter for the target domain and generating a second order interaction value for an item feature from the factor dimensional embedded vector.

In addition, the second order interaction module may include an auxiliary domain second order interaction module (e.g., the MultiAuxiliaryDomainEmbedding module 1016) for generating a factor dimensional embedded vector from at least one parameter of a user or an item for the auxiliary domain and generating a second order interaction value for an auxiliary domain feature from the factor dimensional embedded vector. In addition, the second order interaction module may include a second order interaction value calculation module (e.g., the uia_embedding module 1020, the uia_2way module 1017) for concatenating the second order interaction value for the user feature, the second order interaction value for the item feature and the second order interaction value for the auxiliary domain feature and generating a second order interaction value of the features.

After generating the cross-domain-based FM model, the content streaming system may perform learning by inputting the target domain information and the auxiliary domain information into the cross-domain-based FM model (S1240). Specifically, the cross-domain-based FM model may adjust a weight based on the input target domain information and auxiliary domain information. Herein, the weight may be a value that is applied to feature information that is input into the cross-domain-based FM model. By adjusting the weight through learning, the accuracy of per-user content recommendation may be improved. In addition, learning may include updating a parameter through comparison between a prediction value and a complete watch rate of training data.

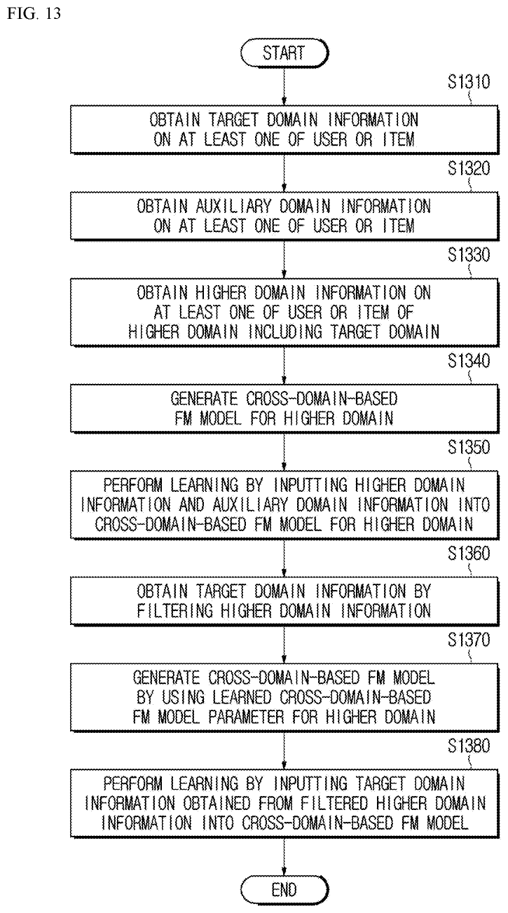

FIG. 13 illustrates a flowchart of 2-step learning of an FM model according to an embodiment of the present disclosure. A content streaming system may obtain target domain information on at least one of a user or an item (S1310). Herein, the target domain information may include a user parameter for a target domain and/or an item parameter for the target domain. The user parameter may be a user identifier, and the item parameter may be an item parameter.

The content streaming system may obtain auxiliary domain information on at least one of a user or an item (S1320). Herein, the auxiliary domain information may include a user parameter for an auxiliary domain and/or an item parameter for the auxiliary domain. The user parameter for the auxiliary parameter may include a content use frequency of a user. In addition, the item parameter may include at least one of an identifier of at least one previously watched content and a complete watch rate of the at least one previously watched content.

The content streaming system may obtain higher domain information on at least one of a user or an item of a higher domain including the target domain (S1330). Herein, the higher domain may mean all domains including the target domain. As used herein, the term “higher domain” is not a relative term of degree, but strictly refers to a comprehensive global domain or a parent domain that entirely encompasses both the target domain and the auxiliary domain within the content streaming system. In addition, the higher domain information may be an item identifier or a user identifier of the higher domain.

The content streaming system may generate a cross-domain-based FM model for the higher domain (S1340). That is, the cross-domain-based FM model may be generated by using the item identifier of the higher domain and the user identifier of the higher domain. In addition, the item identifier of the higher domain and/or the user identifier of the higher domain may be transformed into a form understandable to the FM model by using such a method of one-hot encoding and/or embedding. The transformed user identifier and/or item identifier may be transformed into a sequential vector form through a feature embedding process.

The content streaming system may perform learning by inputting the higher domain information and the auxiliary domain information into the cross-domain-based FM model for the higher domain (S1350). That is, the content streaming system may perform first order learning by using the higher domain information and the auxiliary domain information.

The content streaming system may obtain the target domain information by filtering the higher domain information (S1360). That is, the content streaming system may fix parameters related to a user of the target domain and the auxiliary domain among parameters of the trained FM model for the higher domain and update a parameter related to an item of the target domain. Herein, the target domain information may be an item identifier that is filtered from an item of the higher domain. A filtering process may be performed using a preconfigured logic. For instance, this filtering process is structurally executed by the processor performing a metadata matching operation, which automatically isolates and extracts item identifiers sharing the exact same content metadata tag (e.g., the “action” genre tag) from the database of the higher domain. In addition, the item identifier of the higher domain at step S1330 and the filtered item identifier may be different from each other.

The content streaming system may generate a cross-domain-based FM model by using a learned cross-domain-based FM model parameter for the higher domain (S1370). That is, for second order learning, the content streaming system may regenerate a cross-domain-based FM model by using the learned cross-domain-based FM model parameter for the higher domain.

The content streaming system may perform learning by inputting the target domain information obtained from the filtered higher domain information into the cross-domain-based FM model (S1380). That is, as relearning is performed using only the filtered higher domain information, a time for performing learning based on the higher domain information may be saved. Thus, by performing 2-step learning (first order learning and second order learning), a content streaming system may save a time required for learning and reduce a man hour for generating a new band.

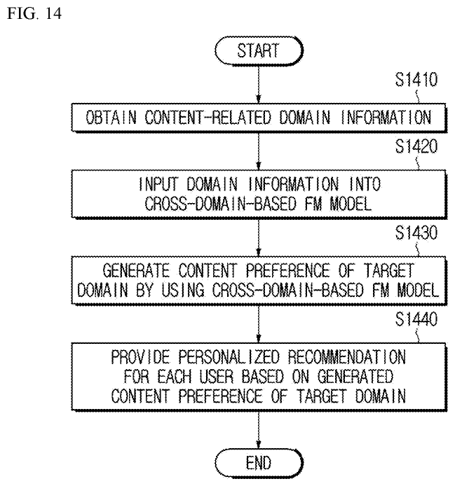

FIG. 14 illustrates a flowchart of a method for content recommendation using a cross-domain-based FM model according to an embodiment of the present disclosure. Referring to FIG. 14, a content streaming system may obtain content-related domain information (S1410). Herein, the domain information may include information indicating a genre or a keyword of a content. Specifically, the domain information may include at least one of information on an item corresponding to a genre or a keyword, information on a user and information on an auxiliary domain, but the present disclosure is not limited thereto, and the domain information may include various information capable of specifying a content.

The content streaming system may input the domain information into a cross-domain-based FM model (S1420). Herein, the cross-domain-based FM model may be a model for which learning is performed based on target domain information for a target domain and auxiliary domain information for an auxiliary domain. Specifically, in order to input the domain information into the cross-domain-based FM model, the content streaming system may determine one model among a plurality of cross-domain-based FM models for the target domain based on information indicating a genre or a keyword of a content. Next, the content streaming system may input the domain information into the determined one FM model.

Next, the content streaming system may generate a content preference of the target domain by using the cross-domain-based FM model (S1430). For example, the cross-domain-based FM model may generate a content preference according to each content genre or keyword for each user. As another example, the cross-domain-based FM model may generate a content preference according to a content keyword for each user.

The content streaming system may provide a personalized recommendation for each user based on the generated content preference of the target domain (S1440). The personalized recommendation for each user may be made by a method of generating a new recommendation band. That is, a recommended content for each user may be provided in a band form. Herein, a new recommendation band may be an interface for recommending a content according to each domain.

The trained cross-domain-based FM model is not merely a mathematical abstraction, but is directly integrated into the content streaming server to automatically and dynamically generate or update a user-specific recommendation interface (e.g., a personalized content band) on the client device. This practically applies the prediction values to transform and improve the concrete graphical user interface of the content streaming system.

A technique of recommending a content based on a cross-domain-based FM model in a content streaming system has been described. However, the present disclosure is not limited thereto, and a content may also be recommended based on a target-domain-based FM model, instead of a cross-domain-based FM model. Herein, input data used for training an FM model and input data used for inference based on the FM model are limited to data of a target domain and a higher domain, and data of an auxiliary domain may be excluded.

The exemplary methods of the present disclosure are represented in a series of operations for clarity of description, but this is not intended to limit the order in which the steps are performed, and each step may be performed simultaneously or in a different order, if necessary. In order to realize a method according to the present disclosure, the steps illustrated may include further other steps, or may include the remaining steps with the exception of some steps, or may include additional other steps with the exception of some steps.

Various embodiments of the present disclosure are not intended to enumerate all possible combinations, but to describe a representative aspect of the present disclosure, and the matters described in the various embodiments may be applied independently or in combination of two or more.

In addition, various embodiments of the present disclosure may be realized by hardware, firmware, software, or a combination thereof. In the case of hardware realization, the embodiments may be realized by one or more ASICs (Application Specific Integrated Circuits), DSPs (Digital Signal Processors), DSPDs (Digital Signal Processing Digital Signal Processing Devices (DSPs), Programmable Logic Devices (PLDs), Field Programmable Gate Arrays (FPGAs), general processors, controllers, microcontrollers, microprocessors, etc.

The scope of the present disclosure includes software or machine-executable commands (e.g., operating systems, applications, firmware, programs, etc.) that allow an operation according to a method of various embodiments to be performed on a device or computer, and a non-transitory computer-readable medium in which such software or commands are stored and executed on the device or computer.

Furthermore, no component described herein or recited in the claims should be construed under the provisions of 35 U.S.C. Section 112(f) unless the exact phrase “means for” or “step for” is explicitly used in the particular claim.

What is claimed is:

1. A method for recommending content in a content streaming system, the method comprising:
obtaining target domain information related to at least one of a user or an item;
obtaining auxiliary domain information related to at least one of a user or an item;
generating a cross-domain-based factorization machine (FM) model; and
performing learning by inputting the target domain information and the auxiliary domain information into the cross-domain-based FM model,
wherein the cross-domain-based FM model comprises:
a first order interaction module configured to generate a first order interaction value for features based on the target domain information and the auxiliary domain information;
a second order interaction module configured to generate a second order interaction value for features based on the target domain information and the auxiliary domain information; and
an output module configured to output a prediction value for a target domain based on the first order interaction value and the second order interaction value.

2. The method of claim 1, wherein the target domain information includes at least one of a user parameter for a target domain or an item parameter for the target domain.

3. The method of claim 2, wherein the user parameter for the target domain indicates a user identifier, and
wherein the item parameter for the target domain indicates an item identifier.

4. The method of claim 1, wherein the auxiliary domain information includes at least one of a user parameter for an auxiliary domain or an item parameter for an auxiliary domain.

5. The method of claim 4, wherein the user parameter for the auxiliary domain indicates a content use frequency of the user, and
wherein the item parameter for the auxiliary domain indicates at least one of an identifier of at least one previously watched content and a complete watch rate for the at least one previously watched content.

6. The method of claim 1, wherein the target domain includes information related to a specific content category to be recommended by the content streaming system.

7. The method of claim 1, wherein the auxiliary domain includes information related to a content category with a high similarity to a specific content category to be recommended by the content streaming system, and
wherein the content category with the high similarity is determined based on comparison between the similarity and a threshold.

8. The method of claim 1, further comprising:
obtaining higher domain information on at least one of a user or an item of a higher domain including the target domain;
generating a cross-domain-based factorization machine (FM) model for the higher domain; and
performing learning by inputting the higher domain information and the auxiliary domain information into the cross-domain-based FM model for the higher domain,
wherein the obtaining of the target domain information comprises obtaining the target domain information by filtering the higher domain information according to the target domain, and
wherein the generating of the cross-domain-based FM model further comprises:
generating the cross-domain-based FM model by using a parameter of the learned cross-domain-based FM model for the higher domain; and
performing the learning by inputting the target domain information obtained from the filtered higher domain information into the cross-domain-based FM model.

9. The method of claim 8, wherein the performing of the learning by inputting the target domain information obtained from the filtered higher domain information into the cross-domain-based FM model comprises fixing a parameter related to a user of the target domain and a parameter related to an auxiliary domain among parameters of the learned FM model for the higher domain, and updating a parameter related to an item of the target domain among parameters of the learned FM model for the higher domain.

10. The method of claim 9, wherein the higher domain information indicates an identifier of a content of the higher domain,
wherein the target domain information indicates an identifier of a content filtered from the content of the higher domain, and
wherein the identifier of the content of the higher domain is different from the identifier of the filtered content.

11. The method of claim 1, wherein the first order interaction module comprises:
a user first order interaction module configured to generate an embedded vector based on a user parameter for the target domain and generate a first order interaction value for a user feature based on the embedded vector;
an item first order interaction module configured to generate an embedded vector based on an item parameter for the target domain and generate a first order interaction value for an item feature based on the embedded vector;
an auxiliary domain first order interaction module configured to generate an embedded vector based on at least one parameter of a user or an item for the auxiliary domain and generate a first order interaction value for an auxiliary domain feature based on the embedded vector; and
a first order interaction value calculation module configured to concatenate the first order interaction value for the user feature, the first order interaction value for the item feature and the first order interaction value for the auxiliary domain feature and generate the first order interaction value of the features based on the concatenated values, and
wherein the second order interaction module comprises:
a user second order interaction module configured to generate a factor dimensional embedded vector based on the user parameter for the target domain and generate a second order interaction value for the user feature based on the factor dimensional embedded vector;
an item second order interaction module configured to generate a factor dimensional embedded vector based on the item parameter for the target domain and generate a second order interaction value for the item feature based on the factor dimensional embedded vector;
an auxiliary domain second order interaction module configured to generate a factor dimensional embedded vector based on at least one parameter of a user or an item for the auxiliary domain and generate a second order interaction value for the auxiliary domain feature based on the factor dimensional embedded vector; and
a second order interaction value calculation module configured to concatenate the second order interaction value for the user feature, the second order interaction value for the item feature and the second order interaction value for the auxiliary domain feature and generate the second order interaction value of the features.

12. The method of claim 1, wherein the prediction value indicates a complete watch rate, and
wherein the learning includes updating a parameter through comparison between the prediction value and a complete watch rate of training data.

13. The method of claim 1, wherein a target domain includes a movie content, and an auxiliary domain includes a broadcast program content.

14. A method for recommending content in a content streaming system, the method comprising:
obtaining domain information related to a content, the domain information comprising at least one of target domain information or auxiliary domain information;
inputting the obtained domain information into a cross-domain-based factorization machine (FM) model;
generating a content preference of a target domain by using the cross-domain-based FM model; and
providing a per-user personalized recommendation based on the generated content preference of the target domain,
wherein the cross-domain-based FM model is generated based on at least one of information related to a user or information related to a content,
wherein the information related to the user comprises target domain information related to the user and auxiliary domain information related to the user, and
wherein the information related to the content comprises target domain information related to the content and auxiliary domain information related to the content,
wherein the inputting of the obtained domain information into the cross-domain-based FM model comprises:
determining one FM model among a plurality of cross-domain-based FM models for the target domain based on information indicating a genre or a keyword of the content; and
inputting the obtained domain information into the determined one FM model,
wherein the generating of the content preference of the target domain by using the cross-domain-based FM model comprises generating a content preference for the genre or the keyword of the content, and
wherein the obtained domain information includes at least one of information on an item corresponding to the genre or the keyword, information on a user, and information on an auxiliary domain.

15. The method of claim 14, wherein the domain information includes information indicating a genre or a keyword of the content.

16. The method of claim 14, wherein the providing of the per-user personalized recommendation comprises generating a new interface for content recommendation based on the generated content preference of the target domain.

17. A device for recommending content in a content streaming system, the device comprising:
a memory configured to store information necessary for operating the device; and
a processor coupled with the memory,
wherein the processor is configured to:
obtain target domain information related to at least one of a user or an item,
obtain auxiliary domain information related to at least one of a user or an item,
generate a cross-domain-based factorization machine (FM) model, and
perform learning by inputting the target domain information and the auxiliary domain information into the cross-domain-based FM model,
wherein the cross-domain-based FM model comprises:
a first order interaction module configured to generate a first order interaction value for features based on the target domain information and the auxiliary domain information;
a second order interaction module configured to generate a second order interaction value for features based on the target domain information and the auxiliary domain information; and
an output module configured to output a prediction value for a target domain based on the first order interaction value and the second order interaction value.
